(19) United States
(12) Patent Application Publication
(10) Pub. No.: US 2025/0234904 A1
(43) Pub. Date: Jul. 24, 2025

(54) KETONE BEVERAGE CONTAINING CAFFEINE AND (R)-1,3-BUTANEDIOL AND/OR (R)-BETA-HYDROXYBUTYRIC ACID AND SALTS

(71) Applicant: KetoneAid, Inc., Falls Church, VA (US)

(72) Inventor: Frank Borges LLOSA, Falls Church, VA (US)

(21) Appl. No.: 19/174,611

(22) Filed: Apr. 9, 2025

Related U.S. Application Data
(63) Continuation of application No. 18/364,136, filed on Aug. 2, 2023.
Application No. 18/364,136 is a division of application No. 17/455,826, filed on Nov. 19, 2021, now abandoned.

(51) Int. Cl. A23L 2/38; A23L 2/56; A23L 2/60; A23L 29/00

(52) U.S. Cl. CPC A23L 2/38; A23L 2/56; A23L 2/60; A23L 29/035

(57) ABSTRACT

The present disclosure relates to an energy-promoting composition including a stimulant, a slow carbohydrate, an exogenous ketone body, and a nootropic agent. The present disclosure also relates to a composition wherein the components beneficially and/or synergistically interact with one another to enhance the overall energy-promoting effect of the composition more rapidly and to a greater degree than if one or more of the components are omitted.

### FIELD OF THE DISCLOSURE

The present disclosure relates to an energy-promoting composition comprising water and a stimulant, a slow carbohydrate, an exogenous ketone body, and a nootropic agent. The present disclosure also relates to a composition wherein the components beneficially and/or synergistically interact with one another to enhance the overall energy-promoting effect of the composition more rapidly and to a greater degree than if one or more of the components are omitted.

### BACKGROUND

Energy drinks are beverages used by consumers to promote wakefulness, maintain alertness, and enhance mood and cognition. Many of the energy drinks on the market typically contain caffeine and sugars (e.g. glucose or carbohydrates). However, both caffeine and sugar come with some drawbacks. Consuming caffeine causes sleep disruptions and can effect sleep quality. Likewise, caffeine can induce anxiety and can be addictive. Glucose consumption, on the other hand, can be associated with so called “energy crash,” whereby the body uses glucose as an immediate fuel source, but experiences a lack of energy or becomes tired once all of the glucose is consumed.

In addition to the drawbacks of caffeine and sugars, typical energy drinks may also affect the brain in undesirable ways, such as by raising stress levels and inducing anxiety, insomnia, gastrointestinal irritation, muscle twitching, and periods of prolonged restlessness.

When glucose or carbohydrates are in short supply, the body can burn fat as an energy source resulting in the production of fatty acid by products called ketones or ketone bodies (e.g. β-hydroxybutyric acid, acetoacetate, and acetone). Alternatively, these ketone bodies can be obtained through an outside source called exogenous ketone bodies. Exogenous ketone bodies are particularly beneficial for supporting stable energy levels without excessive “jitters” and without a rapid crash following consumption.

Accordingly, there is an ongoing need for compositions that are capable of promoting a natural and sustained feeling of wakefulness, maintaining a natural feeling of alertness without jitteriness, increasing concentration, enhancing mood, and/or enhancing cognition without the typical energy crash and without damaging the long-term physiological or mental health of the user.

### SUMMARY

The present disclosure relates to an energy-promoting composition including a stimulant, a slow carbohydrate, an exogenous ketone body, and a nootropic agent. The present disclosure also relates to a composition wherein the components beneficially and/or synergistically interact with one another to enhance the overall energy-promoting effect of the composition more rapidly and to a greater degree than if one or more of the components are omitted. In particular, the present disclosure relates to an energy-promoting composition containing (R)-3-hydroxybutyric acid and esters, salts, and oligomers thereof that are capable of elevating blood levels of (R)-3-hydroxybutyric acid to concentrations sufficient to induce the state of ketosis. In addition, the present disclosure relates to an energy-promoting composition containing (R)-3-hydroxybutyric acid and esters, salts, and oligomers thereof that are capable of elevating blood levels of ketone bodies to concentrations sufficient to induce the state of ketosis and includes a slow release carbohydrate (e.g. isomaltulose).

In some embodiments, the present disclosure is directed to a composition comprising one or more ketone bodies and one or more slow carbohydrates.

In some embodiments, the one or more ketone bodies are selected from the group consisting of a ketone ester, a 3-hydroxybutyric acid salt, 3-hydroxybutyric acid, and combinations thereof.

In some embodiments, the composition further comprising theacrine.

In some embodiments, the composition comprises about 0.009% to about 0.18% by weight of theacrine.

In some embodiments, the composition comprises about 0.13% by weight of theacrine.

In some embodiments, the composition further comprising 1,3-butanediol.

In some embodiments, the 1,3-butanediol is (R) 1,3-butanediol

In some embodiments, the composition further comprising one or more sweeteners.

In some embodiments, the ketone ester is (R)-3-hydroxybutyl (R)-3-hydroxybutanoate.

In some embodiments, the ketone ester (R)-3-hydroxybutyl (R)-3-

hydroxybutanoate comprising an enantiomeric excess of 95%.

In some embodiments, the composition comprises about 0.88% to about 8.8% by weight of (R)-3-hydroxybutyl (R)-3-hydroxybutanoate.

In some embodiments, the composition comprises about 5.3% by weight of (R)-3-hydroxybutyl (R)-3-hydroxybutanoate.

In some embodiments, the 3-hydroxybutyric acid salt is selected from the group consisting of sodium 3-hydroxybutanoate, magnesium 3-hydroxybutanoate, calcium 3-hydroxybutanoate, potassium 3-hydroxybutanoate, and combinations thereof.

In some embodiments, the sweetener is selected from one or more natural sweeteners, non-natural sweeteners, or a combination thereof.

In some embodiments, the composition comprises about 0.88% to about 8.8% by weight of a 3-hydroxybutyric acid salt, 3-hydroxybutyric acid or a combination thereof. In some embodiments, the composition comprises about 4.4% by weight of a

3-hydroxybutyric acid salt, 3-hydroxybutyric acid or a combination thereof. In some embodiments, the slow carbohydrate is selected from isomaltulose,

cluster dextrin, highly branched cyclic dextrin starch, amylopectin, hydrolyzed waxy maize starch, fractionated barley amylopectin, modified corn starch, or a combination thereof. In some embodiments, the slow carbohydrate is isomaltulose.

In some embodiments, the composition comprises about 0.88% to about 13.2% by weight of isomaltulose.

In some embodiments, the composition comprises about 9.7% by weight of isomaltulose.

In some embodiments, the composition is a beverage, drink, gel pack, energy bar, nutritional bar, powder, capsule, or microencapsulated.

In some embodiments, the present disclosure is directed a method of sustaining blood sugar levels in a subject in need thereof, the method comprising administering an effective amount of a composition comprising one or more ketone bodies and one or more slow carbohydrates.

In some embodiments, the present disclosure is directed a method of sustaining blood sugar levels in a subject in need thereof, the method comprising administering an effective amount of a composition comprising a ketone ester, a 3-hydroxybutyric acid salt, 3-hydroxybutyric acid, and one or more slow carbohydrates.

In some embodiments, the method sustains blood sugar level increases or sustains sports performance.

In some embodiments, the sustaining blood sugar levels results in weight loss.

In some embodiments, the subject in need thereof has been diagnosed with alzhemiers, parkingson, ALS, MS, chronic fatigue, a cancer related fatigue.

In some embodiments, the composition is a beverage syrup or a beverage.

In some embodiments, the composition is a beverage.

In some embodiments, the beverage comprises about 0.88% to about 8.8% by weight of ketone ester, 0.88% to about 8.8% by weight of a 3-hydroxybutyric acid salt, 3-hydroxybutyric acid or a combination thereof, about 0.88% to about 13.2% by weight of isomaltulose, and about 0.009% to about 0.18% by weight of theacrine.

In some embodiments, the present disclosure is directed to a composition comprising a ketone body precursor and one or more slow carbohydrates.

In some embodiments, the ketone body precursor is 1,3-butanediol.

### DETAILED DESCRIPTION

It has been surprisingly discovered that particular energy-promoting compositions comprising a stimulant, a slow-release carbohydrate, an exogenous ketone body, and a nootropic agent help maintain ketosis, focus, electrolyte levels, energy sources and endurance. In addition, it has been discovered that the components in certain energy-promoting compositions can beneficially and/or synergistically interact with one another to enhance the overall energy-promoting effect. In certain compositions, subjects needed to consume 50% less ketone bodies to maintain the overall energy-promoting effect as compared to other compositions. In certain embodiments, the exogenous ketone body can be a ketone monoester, a exogenous ketone body precursor, or combination thereof. In certain embodiments, the exogenous ketone body can be administered alone or in combination with one or more exogenous ketone body salts. In certain embodiments, the exogenous ketone body can be administered alone or in combination with a slow-release carbohydrate.

As used herein, “ketosis” refers to a metabolic state wherein a person has elevated levels of ketones or ketone bodies in their blood or urine, usually measured in a person's blood at >0.5 mM/L. Physiologic ketosis is a normal response to low glucose availability, such as low-carbohydrate diets or fasting, and provides an additional energy source for the brain in the form of ketone bodies. Physiologic ketosis can result from any state that increases fatty acid oxidation including fasting, prolonged exercise, or very low-carbohydrate diets such as the ketogenic diet. When physiologic ketosis is induced by carbohydrate restriction, it is sometimes referred to as nutritional ketosis. When glycogen and blood glucose reserves are low, a metabolic shift occurs in order to save glucose for the brain, which is unable to use fatty acids for energy.

As used herein, the phrase “ketone body” means the byproducts from fatty acid metabolism. Exemplary ketone bodies include, but are not limited to, β-hydroxybutyric acid (“BHB”; 3-hydroxybutyric acid; or ketone body free acid), acetoacetate (“AcAc”), and acetone.

As used herein, the phrase “ketone body salt” refers to a base-addition salt of a compound that contains both a ketone group and a carboxylic acid group. Exemplary ketone body salts, include, but are not limited to the sodium, potassium, calcium, and magnesium salts of BHB.

As used herein, the phrase “ketone monoester” is a compound that contains an ester group between a ketone body and an alcohol (e.g. 1,3-butanediol). An example of a ketone monoester is (R)-3-hydroxybutyl (R)-3-hydroxybutanoate.

As used herein, ketone body precursor is a compound that is metabolized or converted to β-hydroxybutyric acid acid. Examples of a ketone body precursor are Medium-chain Triglycerides (MCT-oil) and 1,3-butanediol.

As used herein, a slow release carbohydrate is a compound that can take about 4 to 5 times longer for enzymes to digest in comparison to sucrose. Exemplary slow release carbohydrates include, but are not limited to, isomaltulose (palatinose), complex carbohydrates, cluster dextrin, highly branched cyclic dextrin starch, amylopectin, hydrolyzed waxy maize starch, fractionated barley amylopectin and modified cornstarch. Unlike a fast release carbohydrate (e.g. glucose), isomaltulose fuels the body with carbohydrate energy in a steady and sustained way. The incorporation of a slow release carbohydrate (e.g. isomaltulose) in combination with one or more ketone bodies can prevent large fluctuations in energy levels from fast release carbohydrates, can keep energy levels stable, and can help to maintain a state of ketosis.

Ketosis has been shown to improve brain-function by providing a critical source of energy to fuel starved cells due to a pathologically compromised inability to completely oxidize glucose. More specifically, the inability to completely oxidize glucose has been shown to be a deregulator of pyruvate dehydrogenase. That pathologic impairment is very likely at the root of many well-known neurodegenerative diseases such as Alzheimer's disease, Parkinson's disease, Multiple Sclerosis (MS), and amyotrophic lateral sclerosis (ALS). In addition, the inability to completely oxidize glucose is also likely at the core of the effects of concussions and Traumatic Brain Injuries (TBI). The same impairment is most likely at work in otherwise healthy adults who over time begin to exhibit problems with memory and other cognitive loss.

Maintaining a state of ketosis allows normal cellular activity to obtain the needed energy from ketone bodies and sustains blood sugar levels without any blood sugar spikes as a result of an influx of carbohydrates or glucose, typically from a high carbohydrate diet.

Ketone bodies are particularly beneficial for supporting stable energy levels without excessive “jitters” and without a rapid crash following consumption. The brain can utilize ketone bodies as an energy source, and in many instances, ketone bodies are the preferred source of energy for brain cells. An increase in the proportion of the brain's energy demand met by ketone bodies, as opposed to glucose, beneficially provides a stable and relatively long-lasting energy source to fuel the brain. Ketone bodies can provide a fuel source without causing an insulin spike, as is common with rapid consumption of sugars.

As used here in, exogenous ketone bodies are ketone bodies that come from an outside source (e.g. dietary supplement, energy drink, beverage, etc.) and are not produced in the body

In some embodiments, the present disclosure provides an energy-promoting composition comprising one or more exogenous ketone bodies. In some embodiments, the exogenous ketone body can be selected from the group consisting of β-hydroxybutyric acid, a ketone ester, such as ketone monoester (R)-3-hydroxybutyl (R)-3-hydroxybutanoate, an exogenous ketone body salt or mixture of exogenous ketone body salts (e.g. sodium, magnesium, calcium and potassium salts), and combinations thereof. As used herein, ketone ester refers to a compound that contains one or more ester groups. Examples of ketone esters with more than one ester group are butane-1,3-diyl bis(3-hydroxybutanoate) and 3-((3-((3-hydroxybutanoyl)oxy)butanoyl)oxy) butanoic acid, both of which are shown below.

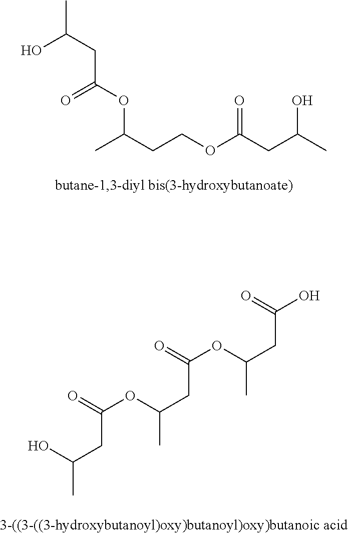 [SMILES: CC(O)CC(=O)OCCC(C)OC(=O)CC(C)O ; CC(O)CC(=O)OC(C)CC(=O)OC(C)CC(=O)O]

In some embodiments, the present disclosure provides an energy-promoting composition comprising a ketone body precursor and one or more slow carbohydrates. In some embodiments, the ketone body precursor can be 1,3-butanediol. In some embodiments, the energy-promoting composition comprising the ketone body precursor and the one or more slow carbohydrates can further comprise any of the other beverage components described herein.

In some embodiments, β-hydroxybutyric acid can be substantially pure (R)-β-hydroxybutyric acid or substantially pure(S)-β-hydroxybutyric acid, or a combination thereof. Exemplary mixtures can comprise, for example, about 80%, about 85%, about 90%, about 95%, about 96%, about 97%, about 98%, about 99%, about 99.9%, or about 99.99% (R)-β-hydroxybutyric acid, with the remainder comprising the other enantiomer. In other embodiments, the mixture can comprise about 80%, about 85%, about 90%, about 95%, about 96%, about 97%, about 98%, or about 99% (S)-β-hydroxybutyric acid, with the remainder being the other enantiomer. In some embodiments, the percentage of (R)-β-hydroxybutyric acid in the mixture can be about 5%, about 10%, about 15%, about 20%, about 25%, about 30%, about 35%, about 40%, about 45%, about 50% (a racemic mixture), about 55%, about 60%, about 65%, about 70%, about 75%, about 80%, about 85%, about 90%, or about 95%.

In some embodiments, the exogenous ketone body can be in the form of an enantiomerically enriched compound as described in WO 2010/021766 (which is hereby incorporated by reference in its entirety), such as 3-hydroxybutyl 3-hydroxybutanoate being enantiomerically enriched with respect to the (3R, 3R′) enantiomer. In some embodiments, the 3-hydroxybutyl 3-hydroxybutyrate can be enantiomerically enriched to about 90%, about 95%, about 96%, about 97%, about 98%, about 99%, about 99.9%, or about 99.99% of the (3R)-hydroxybutyl (3R)-hydroxybutanoate enantiomer. In some embodiments, the 3-hydroxybutyl 3-hydroxybutyrate can be 3-hydroxybutyl (3R)-hydroxybutanoate.

In some embodiments, the ketone ester can be an ester of β-hydroxybutyric acid. In some embodiments, the ketone ester can be selected from the group consisting of the methyl, ethyl, propyl (e.g. n-propyl or 2-propyl), butyl (e.g. tert-butyl), pentyl, hydroxybutyl (e.g. 3-hydroxybutyl), hydroxypropyl, glyceryl (e.g. 2,3-dihydroxypropyl) ester of 3-hydroxybutyric acid, and combinations thereof. In vivo, these ketone esters are de-esterified by esterase enzymes, releasing β-hydroxybutyric acid. Such ketone esters can have improved solubility, increased membrane permeability, improved stability, and/or more sustained release compared to native β-hydroxybutyric acid.

In some embodiments, the exogenous ketone body can be a salt of β-hydroxybutyric acid or a mixture of β-hydroxybutyric acid salts. Exemplary β-hydroxybutyric acid salts include, but are not limited to, sodium, magnesium, calcium, and potassium 3-hydroxybutanoate, and combinations thereof.

Although it is possible to use sodium as the counter ion when preparing salts of β-hydroxybutyric acid, it is desirable, to avoid using sodium in order to avoid exacerbating or causing high blood pressure or other electrolyte imbalances. Excessive sodium ions in the blood may negative health effects related to electrolyte imbalances and particularly sodium/potassium imbalances. In some embodiments, the total amount of cations (e.g., sodium, magnesium, calcium, and potassium) provided by a daily dose of the energy-promoting composition does not exceed four times the recommended daily allowance (RDA) individually or in combination. In some embodiments, the total amount of cations (e.g., sodium, magnesium, calcium, and potassium) provided by a daily dose of the energy-promoting composition does not exceed two times the recommended daily allowance (RDA) individually or in combination. In some embodiments, the total amount of cations (e.g., sodium, magnesium, calcium, and potassium) provided by a daily dose of the energy-promoting composition does not exceed the recommended daily allowance (RDA) individually or in combination.

In some embodiments, the total amount of sodium provided by a daily dose of the energy-promoting composition does not exceed four times the recommended daily allowance (RDA) for sodium, which in the United States is currently 2,400 mg for an adult. In some embodiments, the amount of sodium is no more than three times the RDA, more preferably no more than two times the RDA, and most preferably no more than the RDA for sodium.

In some embodiments, the energy-promoting composition can comprise 1,3-butanediol. In some embodiments, the energy-promoting composition can comprise (R) 1,3-butanediol. In some embodiments, the energy-promoting composition can comprise(S) 1,3-butanediol. In some embodiments, 1,3-butanediol can be enantiomerically enriched (R) 1,3-butanediol. In some embodiments, the 1,3-butanediol can be enantiomerically enriched to about 90%, about 95%, about 96%, about 97%, about 98%, about 99%, about 99.9%, or about 99.99% for (R) 1,3-butanediol.

In some embodiments, the energy-promoting composition can comprise one or more slow carbohydrates. In some embodiments, the one or more slow carbohydrates can be isomaltulose. In some embodiments, the isomaltulose can be included in an amount ranging from about 0.5 g to about 50 g, about 1 g to about 40 g, about 1.5 g to about 30 g, about 2 g to about 25 g, about 2.5 g to about 20 g, about 1 g to about 15 g, about 3 g to about 15 g, about 3.5 g to about 10 g, about 4 g to about 7.5 g, about 4.5 g to about 7 g, about 5 g to about 6.5 g, or about 5.5 g to about 6 g. In some embodiments, the energy-promoting composition can comprise isomaltulose in an amount ranging from about 0.88% to about 13.2% by weight, about 1.8% to about 26% by weight, about 3.5% to about 6.6% by weight, or about 7.1% to about 13% by weight. In some embodiments, the isomaltulose can be included in the energy-promoting composition in an amount of about 1 g, about 1.5 g, about 2 g, about 3.5 g, about 4 g, about 4.5 g, about 5 g, about 5.5 g, about 6 g, about 6.5 g, about 7 g, or about 7.5 g. In some embodiments, the isomaltulose can be present in the energy-promoting composition in an amount of about 0.88% by weight, about 1.8% by weight, about 3.5% by weight, about 4.9% by weight, about 6.6% by weight, about 7.1% by weight, about 9.7% by weight, about 13% by weight, or about 26% by weight.

In some embodiments, the energy-promoting composition can comprise one or more branched chain amino acids (BCAAs). Exemplary BCAAs include L-leucine, L-isoleucine, and L-valine. In some embodiments, the BCAAs can be leucine, isoleucine, valine. In some embodiments, the leucine, isoleucine, and valine can be present in the energy-promoting composition in a 2:1:1 molar ratio. In some embodiments, the BCAAs, L-leucine, L-isoleucine, and I.-valine, can be included in a combined total amount ranging from about 250 mg to about 1000 mg, about 500 mg to about 750 mg and in a molar ratio of 2:1:1. In some embodiments, the energy-promoting composition can comprise a combined total of about 250 mg, about 500 mg, about 750 mg, or about 1000 mg of L-leucine, L-isoleucine, and L-valine in a molar ratio of 2:1:1. In some embodiments, the energy-promoting composition can comprise one or more essential amino acids (EAAs). Exemplary EAAs include histidine, isoleucine, leucine, lysine, methionine, phenylalanine, threonine, tryptophan, and valine.

In some embodiments, the energy-promoting composition can comprise one or more stimulants such as a xanthine alkaloid, an adenosine receptor antagonist, other phosphodiesterase inhibitor, epinephrine and/or norepinephrine promoters, nicotine, or combinations thereof. Exemplary xanthine alkaloids include theacrine, theobromine, theophylline, methylliberine, caffeine, and caffeine analogs. In some embodiments, the one or more stimulants can be theacrine.

In some embodiments, the theacrine can be included in the energy-promoting composition in an amount ranging from about 10 mg to about 400 mg, about 10 mg to about 200 mg, about 50 mg to about 300 mg, about 75 mg to about 200 mg, or about 100 mg to about 200 mg. In some embodiments, the theacrine can be included in an amount ranging from about 0.009% to about 0.18% by weight, about 0.018% to about 0.35% by weight, about 0.13% to about 0.35% by weight, or about 0.07% to about 0.17% by weight.

In some embodiments, the energy-promoting composition can comprise about 10 mg, about 15 mg, about 20 mg, about 25 mg, about 30 mg, about 35 mg, about 40 mg, about 45 mg, about 50 mg, about 55 mg, about 60 mg, about 65 mg, about 70 mg, about 75 mg, about 80 mg, about 85 mg, about 90 mg, about 95 mg, about 100 mg, about 150 mg, about 200 mg, about 250 mg, about 300 mg, about 350 mg, or about 400 mg theacrine. In some embodiments, energy-promoting composition can comprise about 0.009% by weight, about 0.018% by weight, about 0.02% by weight, about 0.04% by weight, about 0.07% by weight, about 0.09% by weight, about 0.13% by weight, about 0.18% by weight, or about 0.35% by weight theacrine.

In some embodiments, the stimulant can be one or more adenosine receptor antagonists, phosphodiesterase inhibitors, epinephrine and/or norepinephrine promoters, or combinations thereof. In some embodiments, the stimulant includes other xanthine alkaloids in addition to or alternative to theacrine, such as caffeine, theobromine, theophylline, methylliberine, other caffeine analogs, or combinations thereof. While most of these compounds are generally effective stimulants, most are also associated with undesirable vasoconstriction and potential increases in blood pressure, as with caffeine. As an exception, theobromine functions as a very mild vasodilator. Theacrine and methylliberine are believed to be somewhat less vasoconstricting than caffeine, though neither are vasodilators and at best still likely have a mild vasoconstricting effect. Exemplary epinephrine and/or norepinephrine promoters include one or more of yohimbine, rauwolscine, ephedra-based compounds such as ephedrine and pseudoephedrine, synephrine, octopamine, 1,3-dimethylamylamine, higenamine, clenbuterol, and adrenaline/noradrenaline reuptake inhibitors such as hordenine and atomoxetine.

In some embodiments, the energy-promoting composition can comprise a nootropic compound to promote cognition, mood, and/or focus, and can there by aid in attenuating the crash effect of the stimulant, in particular the drop in levels of dopamine and/or acetylcholine. In some embodiments, the energy-promoting composition can comprise one or more nootropic compounds. In some embodiments, the nootropic compound can be a dopamine promoter (including dopamine precursors, dopamine receptor agonists, and/or dopamine breakdown or reuptake inhibitors), an acetylcholine promoter (including acetylcholine precursors, acetylcholine receptor agonists, acetylcholinesterase inhibitors, and/or acetylcholine reuptake inhibitors), and/or other nootropic compound(s). Exemplary dopamine promoters include, but are not limited to, methylliberine, theacrine, Mucuna pruriens, tyrosine, L-DOPA (i.e., L-3,4-dihydroxyphenylalanine), phenylalanine, phenylethylamine, tolcapone, or a combination thereof. Exemplary acetylcholine promoters include, but are not limited to, huperzine-A (toothed clubmoss extract (acrial parts) from Huperzia serrata), acetylcholinesterase inhibitor), dimethylaminoethanol, choline, alpha-glycerophosphocholine, uridine, citicoline, racetams such as piracetam, phenylpiracetam, oxiracetam, and aniracetam, or a combination thereof. In some embodiments, the nootropic compound can be a serotonin promoter (e.g., tryptophan, 5-hydroxytryptophan (5-HTP)), beta-alanine, D-serine, phosphatidylserine, Panax ginseng, Ginkgo biloba, Rhodiola rosea, Polygala tenuifolia, Muira puama, Eschscholzia californica, Convolvulus pluricaulis, Centella asiatica, Evolvulus alsinoides, Bacopa monnieri, Epimedium herbs, Ashwagandha herbs, a cyclic adenosine monophosphate (cAMP) modulator such as forskolin or vinpocetine, or a combination thereof. In some embodiments, the nootropic compound can be cordyceps militaris (e.g. cordyceps 10:1).

In some embodiments, the energy-promoting composition can comprise huperzine-A. In some embodiments, the energy-promoting composition can comprise about 1 μg to about 400 μg, 5 μg to about 200 μg, 10 μg to about 100 μg, or 15 μg to about 50 μg huperzine A. In some embodiments, the energy-promoting composition can comprise about 5 μg, about 10 μg, about 15 μg, about 20 μg, about 25 μg, about 30 μg, about 35 μg, about 40 μg, about 45 μg, about 50 μg, about 75 μg, about 100 μg, about 125 μg, or about 150 μg huperzine A.

In some embodiments, the energy-promoting composition can comprise cordyceps 10:1 as the nootropic compound. In some embodiments, the energy-promoting composition can comprise from about 10 mg to about 300 mg, about 50 mg to about 200 mg, or about 75 mg to about 125 mg cordyceps 10:1. In some embodiments, the energy-promoting composition can comprise about 10 mg, about 20 mg, about 30 mg, about 40 mg, about 50 mg, about 60 mg, about 70 mg, about 80 mg, about 90 mg, about 100 mg, about 110 mg, about 120 mg, about 130 mg, about, 140 mg, about 150 mg, about 160 mg, about 170 mg, about 180 mg, about 190 mg, about 200 mg, or about 300 mg cordyceps 10:1.

In some embodiments, the energy-promoting composition can further comprise one or more vasodilators. Exemplary vasodilators include, but are not limited to, quercetin, L-citrulline and salts thereof such as citrulline malate, L-arginine and salts thereof, agmatine and salts thereof, nitrates (extracts from beetroot, celery, cress, chervil, lettuce, spinach, arugula), gallic acid, coenzyme Q10 (CoQ10), trimethylglycine, niacin, theanine, L-theanine, theobromine, garlic, magnesium, grape seed extract, green tea extract, catechins and/or epicatechins (e.g., from green tea or and/or grape seed), proanthocyanidins (e.g., galloylated proanthocyanids), arginase inhibitors such as L-norvaline, nitric oxide synthase promoters such as beta-alanine and/or glutathione, and GABA receptor agonists such as taurine, more specifically L-taurine.

The vasodilator also functions to counteract the vasodilating effects of the stimulant. Most stimulants, including caffeine, cause vasoconstriction and associated increases in blood pressure. This can be harmful to the cardiac and vascular system. Moreover, vasoconstriction reduces blood flow and thereby lowers the efficiency of pharmacokinetic delivery of the energy-promoting composition to the peripheral tissues of the body. The vasodilator beneficially counteracts the negative vasoconstricting effects to the vascular and cardiac systems, and likewise functions to maintain effective blood flow for more efficient delivery of the energy-promoting composition to the peripheral tissues of the body.

In some embodiments, the vasodilators can be L-taurine. In some embodiments, the L-taurine the energy-promoting composition can comprise from about 50 mg to about 500 mg, about 100 to about 400 mg, about 150 to about 300 mg, about 200 to about 300 mg L-taurine. In some embodiments, the energy-promoting composition can comprise about 50 mg, about 100 mg, about 150 mg, about 200 mg, about 250 mg, about 300 mg, about 350 mg, about 400 mg, or about 800 mgL-taurine.

In some embodiments, the vasodilators can be niacin. In some embodiments, the energy-promoting composition can comprise from about 0.1 mg to about 20 mg, about 0.1 mg to about 5 mg, about 0.5 mg to about 4.5 mg, about 1 mg to about 4 mg, about 1.5 mg to about 3.5 mg, or about 2 mg to about 3 mg niacin. In some embodiments, the energy-promoting composition can comprise about 0.1 mg, about 0.5 mg, about 1 mg, about 1.5 mg, about 2 mg, about 2.5 mg, about 3 mg, about 3.5 mg, about 4 mg, about 4.5 mg, about 5 mg, or about 20 mg niacin.

Without wishing to be bound by a particular theory, it is believed that the stimulant beneficially interacts with the exogenous ketone body by enhancing pharmacokinetic absorption and uptake of the exogenous ketone bodies into the tissues so exogenous ketone body can be readily utilized as an energy source. In other words, the stimulant component has been found to increase the efficiency in which the exogenous ketone body is actually taken into cells and metabolized as an energy source.

The exogenous ketone body also affects the stimulant by attenuating the crash effect associated with the stimulant. Inclusion of the exogenous ketone body has been found to beneficially smooth out and/or prolong the experienced energy levels of the user. For example, as compared to a similar composition, that omits exogenous ketone bodies or that replaces them with a sugar ingredient such as fructose, glucose, or sucrose, users report experiencing more sustained and smooth energy levels after consuming an energy-promoting composition containing the exogenous ketone body.

In some embodiments, the energy-promoting composition can comprise an ammonia neutralizing agent. In some embodiments, the ammonia neutralizing agent can be potassium aspartate. In some embodiments, the energy-promoting composition can comprise from about 100 mg to about 500 mg, about 200 mg to about 400 mg, or about 250 mg to about 350 mg beta-alanine. In some embodiments, the energy-promoting composition can comprise about 200 mg, about 250 mg, about 300 mg, about 350 mg, about 400 mg, about 450 mg, or about 500 mg potassium aspartate.

In some embodiments, the energy-promoting composition can comprise a lactic acid neutralizing agent. In some embodiments, the lactic acid neutralizing agent can be beta-alanine. In some embodiments, the energy-promoting composition can comprise from about 100 mg to about 500 mg, about 200 mg to about 400 mg, or about 250 mg to about 350 mg beta-alanine. In some embodiments, the energy-promoting composition can comprise about 200 mg, about 250 mg, about 300 mg, about 350 mg, about 400 mg, about 450 mg, or about 500 gm beta-alanine.

In some embodiments, the energy-promoting composition can comprise one or more energy transport molecules or antioxidants including coenzyme Q10 (CoQ10) or resveratrol. In some embodiments, the one or more energy transport molecules (e.g. a fatty acid transport molecule) or antioxidants can be coenzyme Q10 (CoQ10). In some embodiments, the energy-promoting composition can comprise from about 1 mg to about 50 mg, about 5 mg to about 40 mg, about 10 mg to about 30 mg, or about 15 mg to about 25 mg CoQ10. In some embodiments, the energy-promoting composition can comprise about 10 mg, about 15 mg, about 20 mg, about 25 mg, about 30 mg, about 35 mg, about 40 mg, about 45 mg, or about 50 mg CoQ10. In other embodiments, the one or more energy transport molecules or antioxidants can be resveratrol. In some embodiments, the energy-promoting composition can comprise from about 1 mg to about 50 mg, about 5 mg to about 40 mg, about 10 mg to about 30 mg, or about 15 mg to about 25 mg resveratol. In some embodiments, the energy-promoting composition can comprise about 10 mg, about 15 mg, about 20 mg, about 25 mg, about 30 mg, about 35 mg, about 40 mg, about 45 mg, or about 50 mg resveratol.

In some embodiments, the antioxidant can be L-carnosine. In some embodiments, the energy-promoting composition can comprise from about 1 mg to about 50 mg, about 5 mg to about 40 mg, about 10 mg to about 30 mg, or about 15 mg to about 25 mg. In some embodiments, the L-carnosine may be included in an amount of about 10 mg, about 15 mg, about 20 mg, about 25 mg, about 30 mg, about 35 mg, about 40 mg, about 45 mg, or about 50 mg L-carnosine.

In some embodiments, the energy-promoting composition can comprise one or more fatty acid transport molecules. In some embodiments, the fatty acid transport molecule is acetyl-L-carnitine. In some embodiments, the energy-promoting composition can comprise from about 1 mg to about 50 mg, about 5 mg to about 40 mg, about 10 mg to about 30 mg, or about 15 mg to about 25 mg. In some embodiments, the acetyl-L-carnitine may be included in an amount of about 1 mg, about 5 mg, about 10 mg, about 15 mg, about 20 mg, about 25 mg, about 30 mg, about 35 mg, about 40 mg, about 45 mg, or about 50 mg acetyl-L-carnitine.

In some embodiments, the energy-promoting composition can comprise one or more oxygen transport molecules. In some embodiments, the oxygen transport molecule is vitamin B12 (B12). In some embodiments, the energy-promoting composition can comprise from about 1 μg to about 75 μg, 5 μg to about 50 μg, 10 μg to about 25 μg, or 15 μg to about 20 μg. In some embodiments, the B12 may be included in an amount of about 5 μg, about 10 μg, about 15 μg, about 20 μg, about 25 μg, about 30 μg, about 35 μg, about 40 μg, about 45 μg, about 50 μg, or about 75 μg vitamin B12.

In some embodiments, the energy-promoting composition can comprise one or more flavorings that enhance the taste. Exemplary flavorings include, but are not limited to, sweeteners (e.g., stevia or stevia extracts, sucralose, saccharin, or aspartame), fruit flavors (e.g. monk fruit), mint flavors, other natural flavors, or combinations thereof. In some embodiments, the energy-promoting composition can be sweetened or otherwise flavored to mask any undesirable tastes associated with the ketogenic compound or compounds present in the composition.

In some embodiments, the energy-promoting composition can comprise one or more preservatives. Exemplary preservatives include benzoate and/or sorbate salts. In some embodiments, the energy-promoting composition can comprise about 10 mg, about 15 mg, about 20 mg, about 25 mg, about 30 mg, about 35 mg, about 40 mg, about 45 mg, about 50 mg, about 55 mg, about 60 mg, about 65 mg, about 70 mg, about 75 mg, about 80 mg, about 85 mg, about 90 mg, about 95 mg, about 100 mg, about 150 mg, or about 200 mg potassium sorbate.

Other optional additives include thickeners (e.g., xanthan gum), emulsifiers, flow agents (e.g., silicon dioxide), beet root powder, beta carotene, vitamins (e.g., A, C, D, E, B6, folate), minerals (e.g., iodine, magnesium, zinc, copper, manganese, chromium), fruit extracts, vegetable extracts, enzymes (e.g., amylase, cellulase, lactase, lipase, protease), legume extracts, natural colors (e.g. chlorophyll), cannabidiol (CBD), or combinations thereof, and the like.

In some embodiments, the energy-promoting composition can be administered to support an energy level of the user. In some embodiments, the present disclosure provides a method of delivering an energy-promoting composition to a user that includes 1) providing an energy-promoting composition comprising a stimulant, a vasodilator, and an energy source including an exogenous ketone body; and 2) administering the energy-promoting composition to the user and support an energy level of the user. In some embodiments, the energy-promoting composition promotes a natural and sustained feeling of wakefulness, maintaining a natural feeling of alertness without jitteriness, increasing concentration, enhancing mood, and/or enhancing cognition without the typical energy crash and without damaging the long-term physiological or mental health of the user. In some embodiments, the energy-promoting composition may be taken as needed to promote higher energy levels, to reduce fatigue, to enhance focus, and/or to improve mood. In certain embodiments, the energy-promoting composition may be taken as needed to reduce cancer related fatigue or reduce cancer treatment related fatigue. In some implementations, it can be taken one daily or in multiple doses (e.g., 2, 3, 4 or more) spread throughout the day. In some embodiments, the energy-promoting composition increases athletic activity. In some embodiments, the energy-promoting composition promotes increased or sustained sports performance.

In some embodiments, the energy-promoting composition can sustain blood sugar levels in a subject. In some embodiments, the energy-promoting composition can be administered to a subject in need thereof that has been diagnosed with Alzheimer's, Parkinson, ALS, MS, chronic fatigue, or cancer related fatigue.

In some embodiments, the energy-promoting composition promotes weight loss. In some embodiments, the energy-promoting composition can be used while the user is maintaining a keto or ketogenic diet. As used herein, a keto or ketogenic diet is a diet that is high-fat, adequate-protein, low-carbohydrate diet.

The term “administered”, “administration” or “administering” is used herein to describe the process in which an energy-promoting composition is taken by or delivered to a subject. The composition may be administered in various ways including orally, rectally, or intragastrically, among others, though typical embodiments will be formulated for oral administration. The composition may be by self-administration, ingestion, or consumption by a subject.

In some embodiments, the energy-promoting composition can be formulated as a liquid energy drink. In some embodiments, the liquid energy drink can have a serving size of about 1 mL to about 150 mL, about 5 mL to about 120 mL, about 10 mL to about 80 mL, or about 20 mL to about 60 mL. In some embodiments, the liquid energy drink can have a serving size of about 5 mL, about 10 mL, about 20 mL, about 25 mL, about 30 mL, about 60 mL, about 80 mL, about 120 mL, or about 150 mL. In some embodiments, the liquid energy drink can be supplied in a bulk container. In some embodiments, the bulk container can contain one or more servings. In some embodiments, the bulk container can contain about 1 serving to about 50 servings, about 1 serving to about 35 servings, about 1 serving to about 17 servings, about 1 serving to about 10 servings, about 1 serving to about 8 servings, about 1 serving to about 6 servings, about 1 serving to about 5 servings, about 1 serving to about 4 servings, about 1 serving to about 3 servings, or about 1 serving to about 2 servings In some embodiments, the bulk container can contain about 1 serving, about 2 servings, about 3 servings, about 4 servings about, about 5 servings, about 5.5 servings, about 6 servings, about 7 servings about, about 8 servings, about 9 servings, about 10 servings about, about 11 servings, about 12 servings, about 13 servings about, about 14 servings, about 15 servings, about 16 servings, about 16.5 servings, about 17 servings, about 25 servings, about 33 servings, or about 35 servings. Other embodiments can include other dosage forms. In some embodiments, the energy-promoting composition can be formulated as a beverage powder, which can be reconstituted in water to prepare a liquid energy drink. In some embodiments, the energy-promoting composition can be formulated as a beverage syrup, which can be diluted in water to prepare a liquid energy drink.

As used herein, “dosage form” refers to the structural form the composition is provided in and/or the vehicle by which the energy-promoting composition is delivered to the user. Exemplary dosage forms include, but are not limited to, tablets, capsules, powders, gels, food products, food additives, beverages/drinks (e.g., in cans, bottles, cartons, pouches, squeeze containers, and the like), beverage additives, candies (e.g., suckers, gummies, pastilles), energy bar, nutritional bar, food supplements, sprays, injectable, and suppositories. Some embodiments are formulated as liquids for oral consumption.

As used herein, “unit dose” refers to a dosage form that is configured to deliver a specified quantity or dose of composition thereof. Dosage forms can be configured to provide a full unit dose or fraction thereof (e.g., ½, ⅓, or ¼ of a unit dose). Dosage forms can be configured to provide a full unit dose or multiples thereof (e.g., 2, 3, or 4 times a unit dose).

Another dosage form that can be used to provide a unit dose of composition thereof is a “unit dose measuring device,” such as a cup, scoop, syringe, dropper, spoon, spatula, or colonic irrigation device, which is configured to hold therein a measured quantity of composition equaling a full unit dose, fraction thereof (e.g., ½, ⅓, or ¼ of a unit dose), or multiples thereof (e.g., 2, 3, or 4 times a unit dose). An example use of such measuring device(s) is in kit together with a bulk container.

For example, a “bulk container,” such as a carton, box, can, jar, bag, pouch, bottle, jug, or keg, containing several unit doses of composition (e.g., 1-2, 1-3, 1-4, 1-5, 1-6, 1-7, 1-8, 1-9 or 1-10 unit doses) can be provided to a user together with a unit dose measuring device that is configured to provide a unit dose, or fraction thereof, of composition thereof.

A “kit” for use in providing a composition as disclosed herein in bulk form, while providing unit doses of the composition, can comprise a bulk container holding therein a quantity of composition and a unit dose measuring device configured to provide a unit dose, fraction thereof, or multiples thereof, of composition thereof. One or more unit dose measuring devices can be positioned inside the bulk container at the time of sale, attached to the outside of the bulk container, prepackaged with the bulk container within a larger package, or provided by the seller or manufacture for use with one or multiple bulk containers.

The kit can include instructions regarding the size of the unit dose, or fraction thereof, and the manner and frequency of administration. The instructions can be provided on the bulk container, prepackaged with the bulk container, placed on packaging material sold with the bulk container, or otherwise provided by the seller or manufacturer (e.g., on websites, mailers, flyers, product literature, etc.) The instructions for use can include a reference on how to use the unit dose measuring device to properly deliver a unit dose or fraction thereof. The instructions can additionally or alternatively include a reference to common unit dose measuring devices, such as spoons, spatulas, scoops, droppers, cups, syringes, colonic irrigation device, and the like, not provided with the bulk container (e.g., in case the provided unit dose measuring device is lost or misplaced). In such case, a kit can be constructed by the end user when following instructions provided on or with the bulk container, or otherwise provided by the seller regarding the product and how to properly deliver a unit dose of composition, or fraction thereof.

In some embodiments, the energy-promoting composition is administered in an amount sufficient to raise the blood ketone body concentration to between about 0.1 mM to about 20 mM, about 0.2 mM to about 10 mM, about 2 mM to about 8 mM, about 0.8 mM to about 4.0 mM, or about 1 mM to about 5 mM.

In some embodiments, the energy-promoting composition can comprise about 5 g to about 500 g, about 10 g to about 450 g, about 20 g to about 400 g, about 30 g to about 350 g, about 40 g to about 300 g, about 50 g to about 250 g, about 130 g to about 170 g, 51 g to about 200 g, 51 g to about 150 g, 51 g to about 100 g, 51 g to about 75 g, about 0.5 g to about 200 g, about 1 g to about 200 g, about 1 g to about 100 g, about 1 g to about 10 g, about 0.5 g to about 3 g, about 0.5 g to about 10 g, about 2 g to about 10 g, about 2 g to about 8 g, or about 5 g to about 8 g of an exogenous ketone body or mixtures of exogenous ketone bodies. In some embodiments, the amount of the one or more exogenous ketone bodies can be between about 0.08 g/kg to about 8 g/kg, about 0.1 g/kg to about 5 g/kg, about 0.5 g/kg to about 2 g/kg, about 0.8 to about 4 g/kg, about 0.8 g/kg to about 3 g/kg, about 0.8 g/kg to about 2 g/kg, about 0.8 g/kg to about 1.5 g/kg, about 0.56 g/kg to about 0.83 g/kg, about 0.56 g/kg to about 1.7 g/kg, about 0.56 g/kg to about 2.2 g/kg, about 0.66 g/kg to about 0.96 g/kg, about 0.66 g/kg to about 1.9 g/kg, about 0.66 g/kg to about 2.6 g/kg, to about 0.82 g/kg to about 1.2 g/kg, about 0.82 g/kg to about 2.4 g/kg, about 0.82 g/kg to about 3.2 g/kg, about 0.008 g/kg to about 3.2 g/kg, about 0.16 g/kg to about 3.2 g/kg, about 0.16 g/kg to about 1.6 g/kg, about 0.008 g/kg to about 0.04 g/kg, about 0.008 g/kg to about 0.16 g/kg, about 0.016 g/kg to about 0.16 g/kg, about 0.03 g/kg to about 0.13 g/kg, or about 0.08 g/kg to about 0.13 g/kg, based on the subject's body weight.

In some embodiments, the ketone ester comprises an effective amount of (R)-3-hydroxybutyl (R)-3-hydroxybutanoate. The (R)-3-hydroxybutyl (R)-3-hydroxybutanoate may be included in an amount ranging from about 1 g to about 10 g, about 2 g to about 8 g, about 1 g to about 5 g, about 1.5 g to about 4 g, about 2 g to about 3.5 g, to about 2.5 g to about 3 g. The (R)-3-hydroxybutyl (R)-3-hydroxybutanoate may be included in an amount ranging from about 1.8% to about 18% by weight, about 3.5% to about 14% by weight, about 1.8% to about 9% by weight, about 2.6% to about 7.0% by weight, about 3.5% to about 6.2% by weight, to about 4.4% g to about 5.3% by weight, about 1.7% to about 7.0% by weight, about 0.88% to about 8.8% by weight, about 0.88% to about 4.4% by weight, about 1.3% to about 3.5% by weight, to about 1.7% to about 3.1% by weight, or to about 2.2% to about 2.6% by weight. The (R)-3-hydroxybutyl (R)-3-hydroxybutanoate may be included in an amount of about 3 g or about 6 g. The (R)-3-hydroxybutyl (R)-3-hydroxybutanoate may be included in an amount of about 5.3% by weight.

In some embodiments, the β-hydroxybutyric acid salt, β-hydroxybutyric acid or a combination thereof may be included in an amount ranging from about 1 g to about 10 g, about 1 g to about 5 g, about 1.5 g to about 4 g, about 2 g to about 3.5 g, to about 2.5 g to about 3 g. The 3-hydroxybutyric acid salt, 3-hydroxybutyric acid or a combination thereof may be included in an amount ranging from about 1.8% to about 18% by weight, about 3.5% to about 14% by weight, about 1.8% to about 9% by weight, about 2.6% to about 7.0% by weight, about 3.5% to about 6.2% by weight, to about 4.4% g to about 5.3% by weight, about 1.7% to about 7.0% by weight, about 0.88% to about 8.8% by weight, about 0.88% to about 4.4% by weight, about 1.3% to about 3.5% by weight, to about 1.7% to about 3.1% by weight, or to about 2.2% to about 2.6% by weight. The β-hydroxybutyric acid salt, β-hydroxybutyric acid or a combination thereof may be included in an amount of about 2.5 g or about 5 g. The β-hydroxybutyric acid salt, β-hydroxybutyric acid or a combination thereof may be included in an amount of about 4.4% by weight.

In some embodiments, the sodium ions may be included in an amount ranging from about 50 mg to about 2400 mg, about 100 mg to about 1500 mg, about 100 mg to about 1000 mg, about 100 mg to about 500 mg, about 50 to about 250 mg, or about 125 mg to about 250 mg. In some embodiments, the sodium ions may be included in an amount of about 50 mg, about 75 mg, about 100 mg, about 125 mg, about 200 mg, about 250 mg, about 300 mg, or about 2400 mg.

In some embodiments, the potassium ions may be included in an amount ranging from about 50 mg to about 3500 mg, about 75 mg to about 1500 mg, about 75 mg to about 1000 mg, about 90 mg to about 500 mg, about 90 to about 250 mg, or about 90 mg to about 100 mg. In some embodiments, the potassium ions may be included in an amount of about 50 mg, 75 mg, about 90 mg, about 99 mg, about 100 mg, about 500 mg, about 1000 mg, or about 3500 mg.

In some embodiments, the magnesium ions may be included in an amount ranging from about 10 mg to about 500 mg, about 20 mg to about 400 mg, about 50 mg to about 400 mg, about 50 mg to about 300 mg, about 50 to about 200 mg, or about 50 mg to about 100 mg. In some embodiments, the magnesium ions may be included in an amount of about 10 mg, about 20 mg, about 50 mg, about 60 mg, about 100 mg, about 200 mg, about 300 mg, or about 420 mg.

In some embodiments, the calcium ions may be included in an amount ranging from about 5 mg to about 1300 mg, about 10 mg to about 1000 mg, about 20 mg to about 700 mg, about 20 mg to about 400 mg, about 20 to about 100 mg, or about 20 mg to about 50 mg. In some embodiments, the calcium ions may be included in an amount of about 5 mg, about 10 mg, about 20 mg, about 50 mg, about 100 mg, about 400 mg, about 700 mg, or about 1300 mg.

The energy-promoting composition described herein is further detailed with reference to the examples shown below. These examples are provided for the purpose of illustration only and the embodiments described herein should in no way be construed as being limited to these examples. Rather, the embodiments should be construed to encompass any and all variations which become evident as a result of the teachings provided herein.

### Example 1—Composition 1

| Ingredient | Amount | |
|---|---|---|
| Ketone Ester | 3 | g |
| Exogenous Ketone body salts and | 2.5 g (including 125 mg of | |
| free acid | sodium; 99 mg or potassium; 60 mg | |
| | of magnesium; and 20 mg calcium) | |
| Branched Chain Amino Acids | 750 | mg |
| (L-Leucine, L-Isoleucine, and L- | | |
| Valine in a molar ratio of 2:1:1; | | |
| respectively) | | |
| Beta Alanine | 350 | mg |
| L-Taurine | 200 | mg |
| Cordyceps 10:1 strength | 100 | mg |
| coenzyme Q10 | 20 | mg |
| B12 | 25 | μg |
| Theacrine | 75 | mg |
| Resveratrol | 25 | mg |
| L-Theanine | 20 | mg |
| Isomaltulose | 5.5 | g |
| L-Carnosine | 15 | mg |
| Niacin | 5 | mg |
| Acetyl L Carnitine | 15 | mg |
| Potassium Aspartate | 300 | mg |
| Potassium Sorbate | 60 | mg |
| Natural Chlorophyll | | |
| Monk Fruit | | |
| Stevia | | |

| | |
|---|---|
| Water | To equal 60 mL |

### Example 2—Composition 2

| Ingredient | Amount | |
|---|---|---|
| Ketone Ester | 3 | g |
| Exogenous Ketone body salts and | 2.5 g (including 125 mg of | |
| free acid | sodium; 99 mg or potassium; 60 mg | |
| | of magnesium; and 20 mg calcium) | |
| Branched Chain Amino Acids | 500 | mg |
| (L-Leucine, L-Isoleucine, and L- | | |
| Valine in a molar ratio of 2:1:1; | | |
| respectively) | | |
| Beta Alanine | 350 | mg |
| L-Taurine | 200 | mg |
| Cordyceps 10:1 strength | 100 | mg |
| coenzyme Q10 | 20 | mg |
| B12 | 25 | μg |
| Theacrine | 25 | mg |
| Resveratrol | 25 | mg |
| L-Theanine | 20 | mg |
| Isomaltulose | 5.5 | g |
| L-Carnosine | 15 | mg |
| Niacin | 5 | mg |
| Acetyl L Carnitine | 15 | mg |
| Potassium Aspartate | 300 | mg |
| Potassium Sorbate | 60 | mg |
| Natural Chlorophyll | | |
| Monk Fruit | | |
| Stevia | | |

| | |
|---|---|
| Water | To equal 60 mL |

What is claimed is:

1. A composition comprising,
a) 1,3-butanediol enantiomerically enriched in its (R) isomer; and
b) caffeine or a caffeine analog.

2. The composition of claim 1, further comprising L-theanine, green tea extract, or combinations thereof.

3. The composition of claim 1, wherein the 1,3-butanediol is enantiomerically enriched such that 99.9% of the 1,3-butanediol is (R)-1,3-butanediol.

4. The composition of claim 1, wherein the composition comprises about 0.5 g to about 200 g of 1,3-butanediol enriched in its (R) isomer.

5. The composition of claim 1, wherein the composition further comprises one or more sweeteners.

6. The composition of claim 1, wherein the composition is a beverage, drink, gel pack, energy bar, nutritional bar, powder, capsule, or is microencapsulated.

7. A composition comprising,
a) 1,3-butanediol enantiomerically enriched in its (R) isomer; and
b) L-theanine.

8. The composition of claim 7, further comprising green tea extract, caffeine, a caffeine analog, or combinations thereof.

9. The composition of claim 7, wherein the 1,3-butanediol is enantiomerically enriched such that 99.9% of the 1,3-butanediol is (R)-1,3-butanediol.

10. The composition of claim 7, wherein the composition comprises about 0.5 g to about 200 g of 1,3-butanediol enriched in its (R) isomer.

11. The composition of claim 7, wherein the composition further comprises one or more sweeteners.

12. The composition of claim 7, wherein the composition is a beverage, drink, gel pack, energy bar, nutritional bar, powder, capsule, or is microencapsulated.

13. A composition comprising,
a) β-hydroxybutyric acid enantiomerically enriched in its (R) isomer;
b) β-hydroxybutyric acid salts enantiomerically enriched in its (R) isomer; and
c) caffeine or a caffeine analog.

14. The composition of claim 13, further comprising L-theanine, green tea extract, or combinations thereof.

15. The composition of claim 13, wherein the β-hydroxybutyric acid and β-hydroxybutyric acid salts are enantiomerically enriched such that 99.9% of the β-hydroxybutyric acid is (R)-β-hydroxybutyric acid and 99.9% of the β-hydroxybutyric acid salts are (R)-β-hydroxybutyric acid salts.

16. The composition of claim 13, wherein the composition comprises, collectively, about 0.5 g to about 200 g of:
a) β-hydroxybutyric acid enantiomerically enriched in its (R) isomer; and
b) β-hydroxybutyric acid salts enantiomerically enriched in their (R) isomers.

17. The composition of claim 13, wherein the composition further comprises one or more sweeteners.

18. The composition of claim 13, wherein the composition is a beverage, drink, gel pack, energy bar, nutritional bar, powder, capsule, or is microencapsulated.
